(19) United States
(12) Patent Application Publication
(10) Pub. No.: US 2012/0123647 A1
(43) Pub. Date: May 17, 2012

(54) VEHICLE

(76) Inventors: Katsunori Doi, Tokyo (JP); Masao Ando, Tokyo (JP)

(21) Appl. No.: 12/672,358

(22) PCT Filed: Aug. 7, 2008
(86) PCT No.: PCT/JP2008/064230

§ 371 Date: Apr. 7, 2010

(30) Foreign Application Priority Data
Aug. 7, 2007 (JP) 2007-205900

(51) Int. Cl. G06F 7/00

(52) U.S. Cl. 701/49

(57) ABSTRACT

A vehicle provides a greater maximum acceleration/deceleration, while maintaining a pleasant driving, when M is a total vehicle mass, L is a height of center of gravity of the whole vehicle, λ is a maximum displacement amount of a balancer, and m is a mass of the balancer, the balancer mass m or the maximum displacement amount λ, of the balancer is decided so as to satisfy the following expression: (m/M)(λ/L)=α. By using the expression 1, the balancer mass m and the maximum displacement amount A, of the balancer can be set to an optimal value against the total vehicle mass M. Thus it is possible to decide the balancer mass m and the maximum displacement amount λ for the maximum acceleration α of the vehicle.

### TECHNICAL FIELD

The present invention relates to a vehicle, for example a vehicle that utilizes inverted-pendulum attitude control.

### BACKGROUND ART

Vehicles that utilize inverted-pendulum attitude control (hereinafter simply referred to as “inverted-pendulum vehicles”) are drawing attention. Inverted-pendulum vehicles intended to accommodate a passenger are proposed in the patent documents mentioned below.

Patent Document 1 describes a technique for performing inverted-pendulum control by moving a counterweight (balancer) in accordance with the inclination angle of a vehicle body. Patent Document 2 describes a technique for allowing rapid deceleration by moving a weight during braking.

Patent Document 1: Japanese Patent Application Publication No. JP-A-2004-129435

Patent Document 2: Japanese Patent Application Publication No. JP-A-2004-276727

### DISCLOSURE OF THE INVENTION

### Problem to be Solved by the Invention

In the case where an inverted-pendulum vehicle runs with a passenger riding on the vehicle, the vehicle is desired to achieve a certain level of acceleration (deceleration) in order to meet a demand for the kinematic performance of the vehicle.

In vehicles that perform inverted-pendulum attitude control, it is necessary to move the center of gravity of the vehicle body in accordance with the acceleration. In order to achieve such movement of the center of gravity through vehicle body inclination, however, the vehicle body must occasionally be inclined significantly, which may reduce ride comfort. If the vehicle body is not inclined, the inverted attitude may not be maintained.

In order to maintain the inverted attitude and secure comfort at the same time, it is necessary to suppress the maximum acceleration.

In this respect, in the inverted-pendulum vehicles described in the patent documents mentioned above, the center of gravity can be moved by moving a balancer. However, the balancer itself is too small for the weight of the entire vehicle in consideration of the mass of the entire vehicle (in particular, in the case where the weight of the passenger is included) and the height of the center of gravity, and therefore the movement of the balancer may only serve as a minor adjustment of the position of the center of gravity.

Even if the mass of the balancer is small, it is possible to move the center of gravity significantly by moving the balancer significantly. However, when the balancer is moved within a range allowed by the vehicle size, for example when a balancer of about the same size as the weight 27 in Patent Document 2 is moved by the same amount as the weight 27, the movement of the center of gravity may only serve as a minor adjustment of the attitude control against disturbances that occur when the vehicle is stationary, but may not provide a good effect of moving the center of gravity that significantly reduces the inclination angle of the vehicle body for acceleration/deceleration.

It is therefore an object of the present invention to provide an inverted-pendulum vehicle that provides a greater maximum acceleration/deceleration while maintaining operation comfort.

### Means for Solving the Problem

(1) In order to achieve the foregoing object, the invention according to claim 1 provides a vehicle including: a drive wheel; a vehicle body rotatably supported on a rotary shaft of the drive wheel; a balancer disposed to be movable relative to the vehicle body; and running control means for controlling running while adjusting a center of gravity of the vehicle body by rotating the vehicle body with respect to the rotary shaft and moving the balancer with respect to the vehicle body. In the vehicle, when a gross vehicle mass is defined as M, a height of a center of gravity of the entire vehicle is defined as L, a maximum acceleration/deceleration of the vehicle is defined as α, and a maximum movement amount of the balancer is defined as λ, a mass m of the balancer is defined by m≧(L/λ)αM.

(2) The invention according to claim 2 provides a vehicle including: a drive wheel; a vehicle body rotatably supported on a rotary shaft of the drive wheel; a balancer disposed to be movable relative to the vehicle body; and running control means for controlling running while adjusting a center of gravity of the vehicle body by rotating the vehicle body with respect to the rotary shaft and moving the balancer with respect to the vehicle body. In the vehicle, when a gross vehicle mass is defined as M, a height of a center of gravity of the entire vehicle is defined as L, a maximum acceleration/deceleration of the vehicle is defined as α, a maximum movement amount of the balancer is defined as λ, a distance from a center of gravity of the vehicle body and the balancer to the rotary shaft of the drive wheel is defined as L₁, and a maximum vehicle body inclination angle is defined as 0, a mass m of the balancer is defined by m≧{(L/λ)α−(L₁/λ)θ}M.

(3) The invention according to claim 3 provides a vehicle including: a drive wheel; a vehicle body rotatably supported on a rotary shaft of the drive wheel; a balancer disposed to be movable relative to the vehicle body; and running control means for controlling running while adjusting a center of gravity of the vehicle body by rotating the vehicle body with respect to the rotary shaft and moving the balancer with respect to the vehicle body. In the vehicle, when a gross vehicle mass is defined as M, a height of a center of gravity of the entire vehicle is defined as L, a maximum acceleration/deceleration of the vehicle is defined as α, a maximum movement amount of the balancer is defined as λ, a distance from a center of gravity of the vehicle body and the balancer to the rotary shaft of the drive wheel is defined as L₁, a maximum vehicle body inclination angle is defined as θ, a total mass of the vehicle body and the balancer is defined as M₁, a gross vehicle mass including a rotational inertia-converted mass of the drive wheel is defined as M^{˜}, and a ground contact radius of the drive wheel is defined as R_{W}, a mass m of the balancer is defined by m≧((M₁L₁+M^{˜}R_{W})/λ)α−(M₁L₁/λ)θ□.

(4) The invention according to claim 4 provides a vehicle including: a drive wheel; a vehicle body rotatably supported on a rotary shaft of the drive wheel; a balancer disposed to be movable relative to the vehicle body; and running control means for controlling running while adjusting a center of gravity of the vehicle body by rotating the vehicle body with respect to the rotary shaft and moving the balancer with respect to the vehicle body. In the vehicle, when a gross vehicle mass is defined as M, a height of a center of gravity of the entire vehicle is defined as L, a maximum acceleration/deceleration of the vehicle is defined as α, a maximum movement amount of the balancer is defined as λ, a distance from a center of gravity of the vehicle body and the balancer to the rotary shaft of the drive wheel is defined as L₁, a maximum vehicle body inclination angle is defined as θ, a total mass of the vehicle body and the balancer is defined as M₁, a gross vehicle mass including a rotational inertia-converted mass of the drive wheel is defined as M^{˜}, a ground contact radius of the drive wheel is defined as R_{W}, and φ=tan⁻¹α, a mass m of the balancer is defined by m≧(M₁L₁/λ)tan(φ−θ)+(M^{˜}R_{W}/λ)(sin φ)/(cos(φ−θ))).

(5) The invention according to claim 5 provides a vehicle including: a drive wheel; a vehicle body rotatably supported on a rotary shaft of the drive wheel; a balancer disposed to be movable relative to the vehicle body; and running control means for controlling running while adjusting a center of gravity of the vehicle body by rotating the vehicle body with respect to the rotary shaft and moving the balancer with respect to the vehicle body. In the vehicle, when a gross vehicle mass is defined as M, a height of a center of gravity of the entire vehicle is defined as L, a maximum acceleration/deceleration of the vehicle is defined as α, and a mass of the balancer is defined as m, a maximum movement amount λ of the balancer is defined by λ≧LαM/m.

(6) The invention according to claim 5 provides the vehicle according to any one of claims I to 5, in which the gross vehicle mass M and the mass m of the balancer include a mass m_{M} of a ride section and a passenger riding on the ride section.

(7) The invention according to claim 7 provides the vehicle according to any one of claims 1 to 6, which further includes target acquisition means for acquiring a target running state. In the vehicle, the balancer is formed to include a passenger and a ride section on which the passenger rides, and the running control means controls running while adjusting the center of gravity of the vehicle body by rotating the vehicle body with respect to the rotary shaft and moving the ride section with respect to the vehicle body in accordance with the target running state.

(8) The invention according to claim 8 provides the vehicle according to claim 7, in which the travel control means includes: determination means for determining a drive torque of the drive wheel and movement thrust for moving the ride section in accordance with the acquired target running state; drive means for providing the drive wheel with the drive torque determined by the determination means; and ride section movement means for providing the ride section with the movement thrust determined by the determination means.

(9) The invention according to claim 9 provides the vehicle according to claim 8, which further includes: target inclination angle determination means for determining a target inclination angle for rotating the vehicle body in accordance with the target running state; and target position determination means for determining a target position for moving the ride section on the basis of the target running state and the target inclination angle. In the vehicle, the running control means controls running while adjusting the center of gravity of the vehicle body by controlling rotation of the vehicle body and movement of the ride section in accordance with the target running state, the target inclination angle, and the target position.

### Effects of the Invention

According to the invention of claim 1, the balancer mass is set to an appropriate value for the gross mass of the vehicle. Thus, it is possible to improve the maximum acceleration of the vehicle and secure operation comfort at the same time.

According to the invention of claim 2, movement of the center of gravity achieved through vehicle body inclination is taken into account with the distance from the center of gravity of the vehicle body and the balancer to the rotary shaft of the drive wheel defined as L₁ and the maximum inclination angle of the vehicle body defined as θ. Thus, it is possible to further improve the maximum acceleration of the vehicle and secure operation comfort by setting the balancer mass more appropriately.

According to the invention of claim 3, the rotational inertia of the drive wheel is also taken into account with the total mass of the vehicle body and the balancer defined as M₁, the gross vehicle mass including the rotational inertia-converted mass of the drive wheel defined as M^{˜}, and the ground contact radius of the drive wheel defined as R_{W}. Thus, it is possible to further improve the maximum acceleration of the vehicle and secure operation comfort by setting the balancer mass more appropriately.

According to the invention of claim 4, non-linear elements are taken into account with φ=tan⁻¹α. Thus, it is possible to further improve the maximum acceleration of the vehicle and secure operation comfort by setting the balancer mass more appropriately.

According to the invention of claim 5, the maximum movement amount of the balancer is set to an appropriate value for the gross mass of the vehicle. Thus, it is possible to further improve the maximum acceleration of the vehicle and secure operation comfort.

According to the invention of claim 6, the gross vehicle mass M and the mass m of the balancer include an assumed mass m_{M} of an on-board object in order to take the mass in the running state into account with more exactness. Thus, it is possible to set the mass of the balancer to a more appropriate value.

According to the invention of claim 7, the balancer is formed to include a passenger and a ride section on which the passenger rides, and running is controlled while adjusting the center of gravity of the vehicle body by rotating the vehicle body with respect to the rotary shaft and moving the ride section with respect to the vehicle body in accordance with the target running state. Thus, it is possible to provide a vehicle that provides the passenger with good ride comfort by suppressing the inclination angle of the vehicle body.

According to the invention of claim 8, the drive torque of the drive wheel and the movement thrust for moving the ride section are determined in accordance with the target running state, the drive torque is provided to the drive wheel, and the movement thrust is provided to the ride section. Thus, it is possible to control the vehicle body inclination amount and the ride section position appropriately.

According to the invention of claim 9, the target position of the ride section and the drive torque are determined in accordance with the target inclination angle of the vehicle body. Thus, it is possible to provide a vehicle that provides the passenger with good ride comfort by allowing acceleration/deceleration while keeping a desired vehicle body inclination angle.

### BRIEF DESCRIPTION OF THE DRAWINGS

FIG. 1 illustrates a dynamic model of a vehicle attitude control system including a balancer according to an embodiment.

FIG. 2 illustrates a state in which movement of a ride section allows acceleration with a small inclination angle in the embodiment.

FIG. 3 shows an exemplary external configuration of a vehicle according to the embodiment in a state in which the vehicle is running forward with a passenger riding on the vehicle.

FIG. 4 shows the configuration of a control system according to a first embodiment.

FIG. 5 is a flowchart of running/attitude control according to the first embodiment.

FIG. 6 shows the relationship between a target vehicle acceleration α* (horizontal axis) and a target vehicle body inclination angle θ₁* and a target ride section position λ_{S}*.

FIG. 7 is a flowchart of a target value determination process according to a modification of the first embodiment.

### DESCRIPTION OF THE REFERENCE NUMERALS

11 DRIVE WHEEL
12 DRIVE MOTOR
13 RIDE SECTION
14 SUPPORT MEMBER
131 SEAT SURFACE PORTION
132 BACKREST PORTION
133 HEADREST
16 CONTROL UNIT
20 CONTROL ECU
21 MAIN CONTROL ECU
22 DRIVE WHEEL CONTROL ECU
23 RIDE SECTION CONTROL ECU
30 INPUT DEVICE
31 JOYSTICK
41 VEHICLE BODY INCLINATION SENSOR
50 DRIVE WHEEL CONTROL SYSTEM
51 DRIVE WHEEL SENSOR
52 DRIVE MOTOR
60 RIDE SECTION CONTROL SYSTEM
61 RIDE SECTION SENSOR
62 RIDE SECTION MOTOR
63 MOVEMENT MECHANISM

### BEST MODES FOR CARRYING OUT THE INVENTION

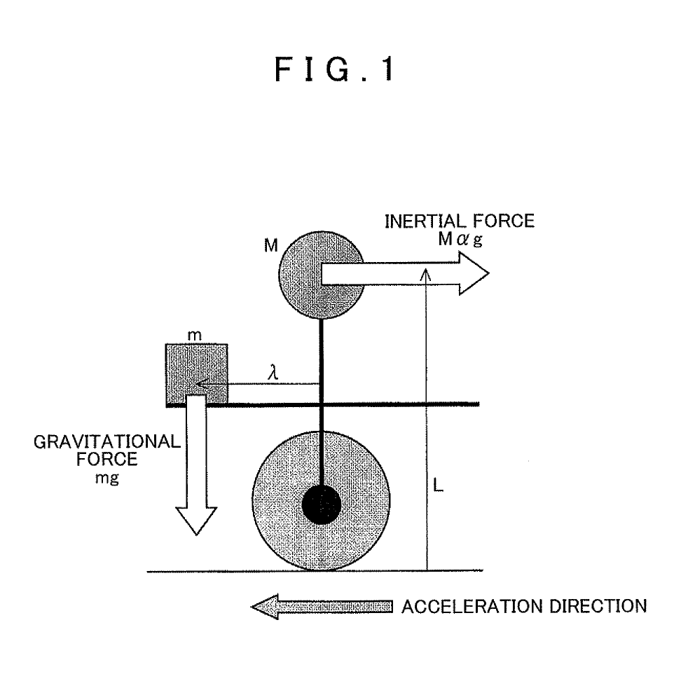

A vehicle according to a preferred embodiment of the present invention will be described in detail below with reference to FIGS. 1 to 7.

### (1) Outline of Embodiment

FIG. 1 illustrates a dynamic model of a vehicle attitude control system including a balancer according to an embodiment.

In the embodiment, when the gross vehicle mass including a passenger and baggage is defined as M, the height of the center of gravity of the entire vehicle including the passenger and the baggage from the ground surface with the vehicle body standing upright is defined as L, the maximum acceleration set as running performance required of the vehicle is defined as α, the maximum movement amount of the balancer which moves relatively from the center of the vehicle body is defined as λ, and the mass of the balancer is defined as m, the mass m of the balancer or the maximum movement amount λ of the balancer is determined such that Formula 1 below is met.

The balancer according to the embodiment is formed by a ride section and other portions, in order that the balancer has a mass m determined by each formula or a mass m set to determine the maximum movement amount λ.

However, the balancer is mainly formed by the ride section, and therefore in the embodiment the balancer with a mass m is conveniently described as the ride section.

(m/M)(λ/L)=α (Formula 1)

From Formula 1, the mass m and the maximum movement amount λ of the balancer can be determined for the gross vehicle mass M, the height L of the center of gravity of the vehicle, and the maximum acceleration α of the vehicle.

In the embodiment, it is assumed that the maximum acceleration and the maximum deceleration of the vehicle are equal to each other, and that the maximum forward movement amount and the maximum backward movement amount of the balancer are equal to each other. However, they may be different from each other. In such cases, respective conditions are obtained by correlating the maximum acceleration and the maximum forward movement amount and correlating the maximum deceleration and the maximum backward movement amount in Formula 1, and the mass m, the maximum forward movement amount, and the maximum backward movement amount of the balancer are determined such that both the conditions are met. The above assumption and the method to be employed when such an assumption is not true also apply to the description below.

The balancer (active weight portion) is formed by the entire ride section including the passenger. The gross vehicle mass M and the balancer mass m are defined to include an assumed mass m_{M} of the passenger in advance. In the case where the balancer mass m including the ride section and the passenger mass m_{M} is not sufficient, the balancer is formed to include a control section and/or a battery.

By forming the balancer in this way, the balancer weight is increased for the vehicle weight, which secures operation comfort while significantly improving the maximum acceleration/deceleration.

For example, a vehicle that can support an acceleration/deceleration of up to 0.1 G when the vehicle body is inclined by 10 degrees is considered. In the case where no balancer is provided, or in the case where a small balancer as described in the above patent documents is provided, it is necessary to incline the vehicle body backward by 40 degrees in order to perform braking at 0.4 G.

In contrast, in the vehicle according to the embodiment, the ride section which has a mass with a large proportion for the gross vehicle mass M is movable, which provides the effect of moving the center of gravity significantly. Thus, for example, the vehicle according to the embodiment can support an acceleration/deceleration of 0.1 G by moving the ride section by 10 cm without inclining the vehicle body.

Therefore, for example, the vehicle according to the embodiment can perform braking at 0.4 G by moving the seat by 30 cm and inclining the vehicle body backward by only 10 degrees.

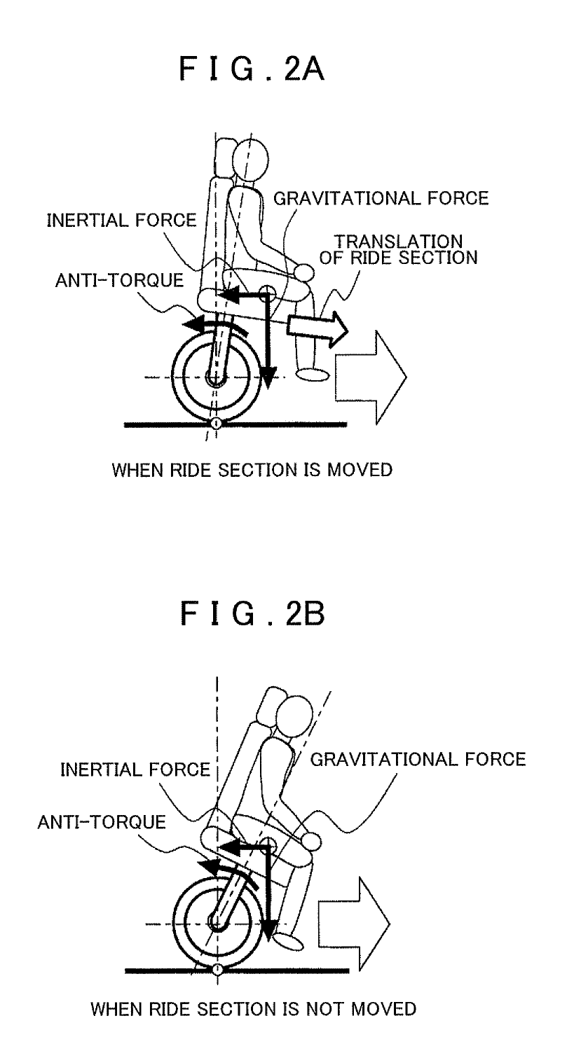

FIG. 2 illustrates a state in which movement of the ride section allows acceleration with a small inclination angle in the embodiment.

In the embodiment, the ride section including the passenger is relatively translated in the front-rear direction of the vehicle to keep balance (the inverted state) of the vehicle body.

That is, as shown in FIG. 2A, the ride section including the passenger is translated in the acceleration direction to keep balance with an anti-torque of the drive wheel that acts on the vehicle body due to acceleration/deceleration according to the target running state (such as acceleration, deceleration, and stop) based on an operation performed by the passenger and with an inertial force caused by the acceleration.

It is thus possible to reduce the inclination angle of the vehicle body for the acceleration/deceleration, which provides a comfortable and safe inverted-pendulum vehicle.

### (2) Details of First Embodiment

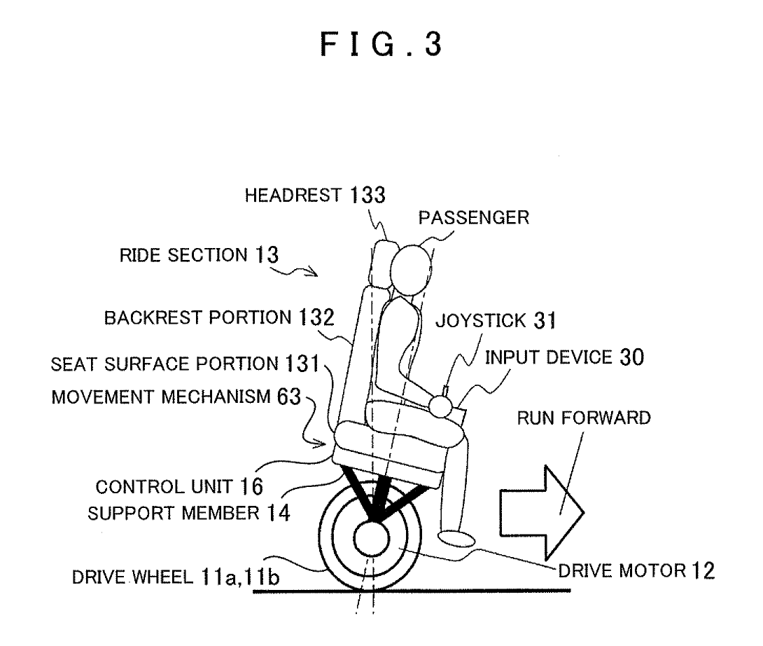

FIG. 3 shows an exemplary external configuration of a vehicle according to the embodiment in a state in which the vehicle is running forward with a passenger riding on the vehicle.

As shown in FIG. 3, the vehicle includes two drive wheels 11a and 11b disposed coaxially with each other.

The drive wheels 11a and 11b are respectively driven by drive motors 12a and 12b.

The number of drive wheels and drive motors of the vehicle that are disposed coaxially with each other is not limited to two, and one wheel and one drive motor, or three or more drive wheels and three or more drive motors, may be disposed coaxially with each other.

A ride section 13 (seat) on which heavy objects such as baggage and a passenger are to be placed is disposed above the drive wheels 11a and 11b (referred to as drive wheels 11 in the case where both the drive wheels 11a and 11b are indicated, which also applies to other components hereinafter) and the drive motors 12.

The ride section 13 includes a seat surface portion 131 on which the operator is to be seated, a backrest portion 132, and a headrest 133.

In the embodiment, a balancer is formed by the ride section 13 and the passenger (with an assumed mass of m_{M}).

The mass m of the ride section 13 (balancer) according to the embodiment is determined on the basis of the values of the gross vehicle mass M, the height L of the center of gravity of the entire vehicle, the maximum acceleration/deceleration α of the vehicle, and the maximum movement amount λ of the balancer in accordance with Formula 2 below which is obtained from Formula 1 above.

In Formula 2, the maximum movement amount λ of the balancer is the amount of relative movement in the front-rear direction of the vehicle body with reference to a plumb line passing through the rotary shaft of the drive wheels 11 with the vehicle body standing upright.

The ride section mass in and the gross vehicle mass M include an assumed mass m_{M} of the passenger.

m=(L/λ)αM (Formula 2)

The ride section 13 is supported by a support member 14 via a movement mechanism 63. The support member 14 is fixed to a drive motor housing that houses the drive motors 12.

The movement mechanism 63 may be a linear movement mechanism with a low resistance such as a linear guide device, for example, and changes the relative positions of the ride section 13 and the support member 14 using a drive torque produced by a ride section drive motor.

The linear guide device includes a guide rail fixed to the support member 14, a slider fixed to the ride section drive motor, and rolling elements.

The guide rail has two track grooves formed in left and right side surfaces to extend straight along the longitudinal direction.

The slider is formed to have a U-shaped cross section, and has two track grooves formed in inner sides of two opposing side surfaces to respectively oppose the track grooves of the guide rail.

The rolling elements are embedded between the track grooves described above to roll in the track grooves as the guide rail and the slider move linearly relative to each other.

The slider is formed to have a return passage that connects both ends of the track grooves to allow the rolling elements to circulate between the track grooves and the return passage.

The linear guide device is provided with a brake (clutch) that locks movement of the linear guide device. When operation of the ride section is not necessary, for example when the vehicle is stationary, the brake is engaged to fix the slider with respect to the guide rail in order to retain the relative positions of the support member 14 to which the guide rail is fixed and the ride section 13 to which the slider is fixed. When operation of the ride section is necessary, the brake is disengaged to control the distance between the reference position of the support member 14 and the reference position of the ride section 13 to a predetermined value.

An input device 30 is disposed beside the ride section 13. The input device 30 includes a joystick 31.

The operator operates the joystick 31 to issue a command for causing the vehicle to accelerate, decelerate, make a turn, rotate on the spot, stop, brake, and so forth.

While the input device 30 is fixed to the seat surface portion 131 in the embodiment, the input device 30 may be formed by a remote controller connected via a wire or wirelessly. Alternatively, the input device 30 may be disposed on top of an armrest.

While the input device 30 is provided in the vehicle according to the embodiment, the input device 30 may be replaced with a running command data acquisition section in the case of a vehicle that runs automatically in accordance with predetermined running command data. The running command data acquisition section may be formed, for example, by reading means for acquiring running command data from various storage media such as a semiconductor memory, and/or communication control means for acquiring running command data from the outside through wireless communication.

While FIG. 3 shows a case where a passenger rides on the ride section 13, the present invention is not limited to vehicles operated by a passenger, and is also applicable to vehicles that run and stop in accordance with a remote control operation performed from the outside or running command data, with only baggage placed on the vehicle or with no load placed on the vehicle.

A control unit 16 is disposed between the ride section 13 and the drive wheels 11.

In the embodiment, the control unit 16 is attached to the support member 14.

The control unit 16 may be attached to the underside of the seat surface portion 131 of the ride section 13. In this case, the control unit moves in the front-rear direction together with the ride section 13 through the movement mechanism 63.

The vehicle according to the embodiment additionally includes a battery. The battery is carried by the support member 14, and supplies electric power for driving and computation to the drive motors 12, the ride section drive motor, the control ECU 20, and so forth.

In the description below, the drive wheels 11 and components fixed thereto to rotate together therewith are referred to as “drive wheels”, components of the entire vehicle including the passenger except for the drive wheels are referred to as “vehicle body”, and the ride section 13 and components (including the passenger) fixed thereto to translate together therewith are referred to as “ride section”.

While the “ride section” is formed by the ride section 13, the input device 30, and a part of the movement mechanism 63 (linear guide) in the embodiment, the control unit 16 and the battery may be disposed in the ride section 13 to be included in the “ride section”. This increases the weight of the “ride section” and hence the effect of moving the “ride section”.

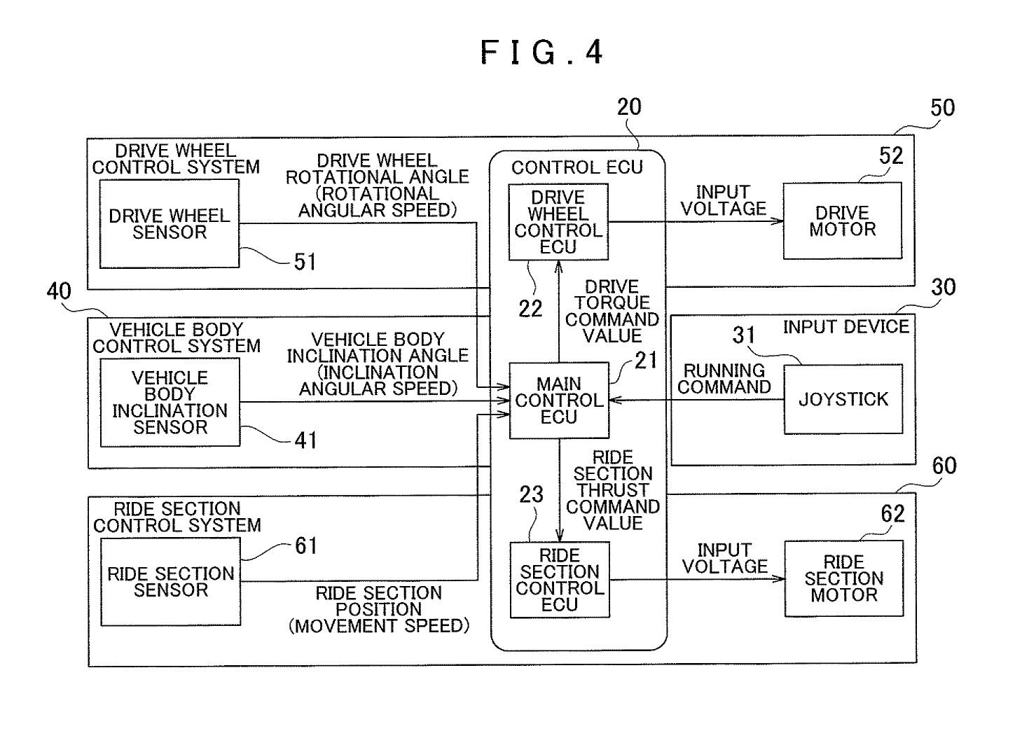

FIG. 4 shows the configuration of a control system according to the embodiment.

The control system includes a control ECU (electronic control unit) 20 that functions as running attitude control means, the joystick 31, a vehicle body inclination sensor 41, a drive wheel sensor 51, a drive motor 52 (which is the same as the drive motors 12), a ride section sensor 61, a ride section motor 62 (ride section drive motor), and other devices.

The control ECU 20 includes a main control ECU 21, a drive wheel control ECU 22, and a ride section control ECU 23, and performs various controls such as running control of the vehicle and attitude control through drive wheel control and vehicle body control (inverted-pendulum control).

The control ECU 20 is formed by a computer system including a ROM that stores various programs and data such as a running/attitude control processing program according to the embodiment, a RAM used as a work area, an external storage device, an interface section, and so forth.

The drive wheel sensor 51, the vehicle body inclination sensor 41, the ride section sensor 61, and the joystick 31 serving as the input device 30 are connected to the main control ECU 21.

The joystick 31 supplies the main control ECU 21 with a running command (operation amount) based on an operation performed by the passenger.

The joystick 31 is in the neutral position when the joystick 31 stands upright. Inclining the joystick 31 in the front-rear direction commands acceleration/deceleration, and inclining the joystick 31 in the left-right direction commands lateral acceleration for making a turn. As the inclination angle becomes greater, the required acceleration/deceleration or lateral acceleration also becomes greater.

The vehicle body inclination sensor 41 functions as inclination detection means for detecting the inclination angle of the vehicle body, and detects the state of inclination of the vehicle body in the front-rear direction about the axle of the drive wheels 11.

The vehicle body inclination sensor 41 includes an acceleration sensor that detects acceleration and a gyro sensor that detects the vehicle body inclination angular speed. The vehicle body inclination angle θ₁ is calculated from the detected acceleration and from the detected vehicle body inclination angular speed at the same time, which increases the calculation accuracy. It is also possible to provide only one of the sensors, and to calculate the vehicle body inclination angle or the angular speed from a value detected by the sensor.

The main control ECU 21 functions as target running state acquisition means for acquiring the target running state. The main control ECU 21 further functions as output determination means for determining a drive torque of the drive wheels and movement thrust of the ride section in accordance with the acquired target running state.

The main control ECU 21 functions as target attitude determination means for determining the target vehicle body inclination angle and the target ride section position in accordance with the target running state based on a signal from the joystick 31.

The main control ECU 21 also functions as feedforward output determination means for determining a feedforward output of each actuator (the drive motor 52 and the ride section motor 62) in accordance with the target running state and the target attitude (the target vehicle body inclination angle and the target ride section position).

The main control ECU 21 further functions as feedback output determination means for determining a feedback output of the drive motor 52 in accordance with the deviation between a target value and a measurement value of the vehicle body inclination angle, and for determining a feedback output of the ride section motor 62 in accordance with the deviation between a target value and a measurement value of the ride section position.

The main control ECU 21, together with the drive wheel control ECU 22 and the drive motor 52, functions as drive means. The main control ECU 21, the drive wheel control ECU 22, the drive motor 52, and the drive wheel sensor 51 form a drive wheel control system 50.

The drive wheel sensor 51 detects the drive wheel rotational angle (rotational angular speed) which is the rotational state of the drive wheels 11, and supplies the main control ECU 21 with the detection results. The drive wheel sensor 51 according to the embodiment is formed by a resolver that detects the drive wheel rotational angle. The drive wheel rotational angle is used to calculate the rotational angular speed.

The main control ECU 21 supplies the drive wheel control ECU 22 with a drive torque command value. The drive wheel control ECU 22 supplies the drive motor 52 with an input voltage (drive voltage) equivalent to the drive torque command value. The drive motor 52 functions as a drive wheel actuator that provides a drive torque to the drive wheels 11 in accordance with the input voltage.

The main control ECU 21, the ride section control ECU 23, the ride section sensor 61, and the ride section motor 62 form a ride section control system 60.

The ride section sensor 61 functions as position detection means for detecting the relative position of the ride section, and supplies the main control ECU 21 with data on the detected ride section position (movement speed). The ride section sensor 61 according to the embodiment is formed by an encoder that detects the ride section position. A detection value of the ride section position is used to calculate the movement speed of the ride section.

The main control ECU 21 supplies the ride section control ECU 23 with a ride section thrust command value. The ride section control ECU 23 supplies the ride section motor 62 with an input voltage (drive voltage) equivalent to the ride section thrust command value. The ride section motor 62 functions as a ride section actuator that provides thrust for translating the ride section 13 in accordance with the input voltage.

Now, a running/attitude control process performed by the vehicle configured as described above will be described.

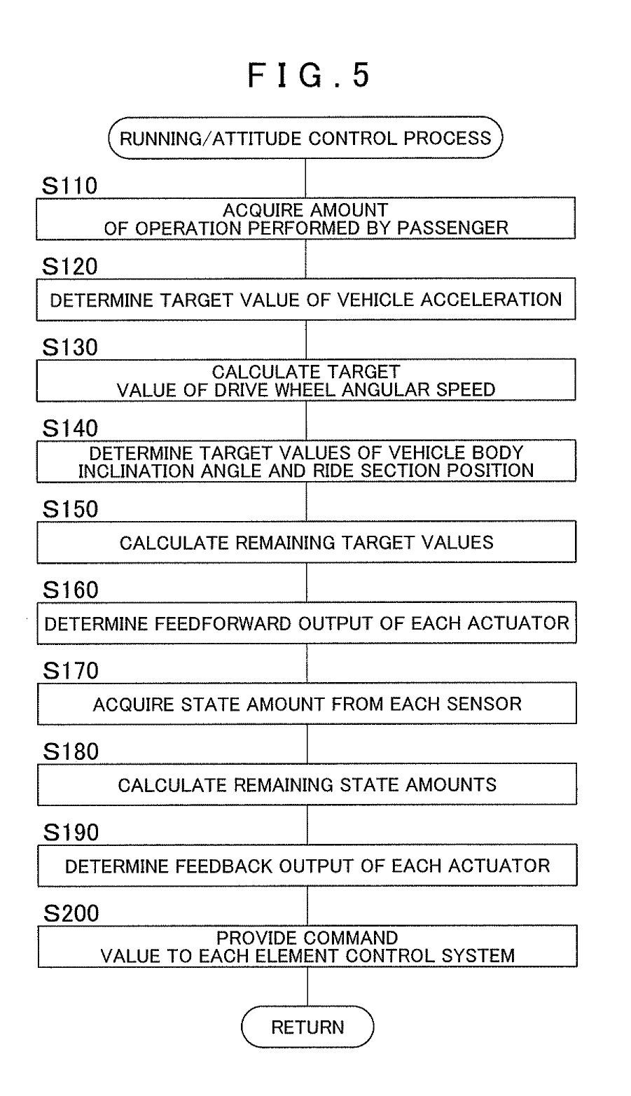

FIG. 5 is a flowchart showing the content of the running/attitude control process.

First, the outline of the entire running/attitude control process is described.

In the running/attitude control according to the embodiment, the vehicle body inclination and the ride section position are controlled in accordance with the target running state such as acceleration/deceleration and stop to achieve the target running state while keeping balance of the vehicle body.

The main control ECU 21 first determines how the vehicle will be moved, that is, the running target of the vehicle, in accordance with the intension of the passenger (steps 110 to 130).

The main control ECU 21 then determines the target vehicle body attitude (the target vehicle body inclination angle and the target ride section position) that will keep balance of the vehicle body (that will keep the inverted attitude) for the determined running target (step 140).

By optimizing the vehicle body inclination amount and the ride section position as described above, it is possible to provide the passenger with an appropriate sense of acceleration while preventing deterioration in ride comfort by reducing the vehicle body inclination.

The main control ECU 21 then determines output values of the drive motor 52 and the ride section motor 62 necessary to achieve the target vehicle running state and the target vehicle body attitude. The drive wheel control ECU 22 and the ride section control ECU 23 control actual outputs of the drive motor 52 and the ride section motor 62 in accordance with the determined values (steps 150 to 200).

Now, the running/attitude control process is described in detail.

The main control ECU 21 acquires the amount of operation (running command) of the joystick 31 performed by the passenger (step 110).

The main control ECU 21 then determines a target value of the vehicle acceleration (target vehicle acceleration) α* on the basis of the acquired operation amount (step 120). For example, the target vehicle acceleration α* is set to a value proportional to the amount of operation of the joystick 31 in the front-rear direction.

The main control ECU 21 calculates a target value of the drive wheel angular speed (target drive wheel angular speed) [θω*] from the determined target vehicle acceleration α* (step 130).

The symbol [n] represents a time differential of n. For example, the target drive wheel angular speed [θω*] is calculated as a value obtained by integrating the target vehicle acceleration α* with respect to the time and dividing the resulting value by a predetermined drive wheel ground contact radius.

The main control ECU 21 then determines target values of the vehicle body inclination angle and the ride section position (step 140). That is, the main control ECU 21 determines a target value of the vehicle body inclination angle (target vehicle body inclination angle) θ₁* using one of Formulas 3 to 5 below depending on the magnitude of the target vehicle acceleration α* determined in step 120.

The main control ECU 21 then determines a target value of the ride section position (target ride section position) λ_{S}* on the basis of the determined target vehicle body inclination angle θ₁* using one of Formulas 6 to 8 below depending on the magnitude of the target vehicle acceleration α*.

θ₁*=φ*−β_{Max}+sin⁻¹(γ sin φ*cos β_{Max})(α*<−α_{Max}) (Formula 3)

θ₁*=(1−Cₛₑₙₛₑ)φ*(−α_{Max}≦α*≦α_{Max}) (Formula 4)

θ₁*=φ*+β_{Max}+sin⁻¹(γ sin φ*cos β_{Max})(α*>α_{Max}) (Formula 5)

λ_{S}*=−λ_{S,Max}(α*<−α_{Max}) (Formula 6)

λ_{S}*=1₁(m₁/m_{S}){tan(φ*−θ₁*)+γ(sin φ*/cos(φ*−θ₁*))}(−α_{Max}≦α*≦α_{Max}) (Formula 7)

λ_{S}*=λ_{S,Max}(α*>α_{Max})

In Formulas 3 to 8, φ*, β_{Max}, and γ are defined as follows.

φ*=tan⁻¹α*

β_{Max}=tan⁻¹(m_{S}λ_{S,Max}/m₁1₁)

γ=M^{˜}R_{W}/m₁1₁,M^{˜}=m₁+m_{W}+I_{W}/R_{W}²

α* is the target vehicle acceleration (G). λ_{S,Max} is the maximum ride section movement amount which is a set value.

The threshold α_{Max} is the target vehicle acceleration α* with λ*=λ_{S,Max} in Formula 7, that is, with the ride section moved to a limit. The threshold α_{Max}, which is a preset value, cannot be calculated analytically, and is therefore determined through repeated calculations or using an approximate formula.

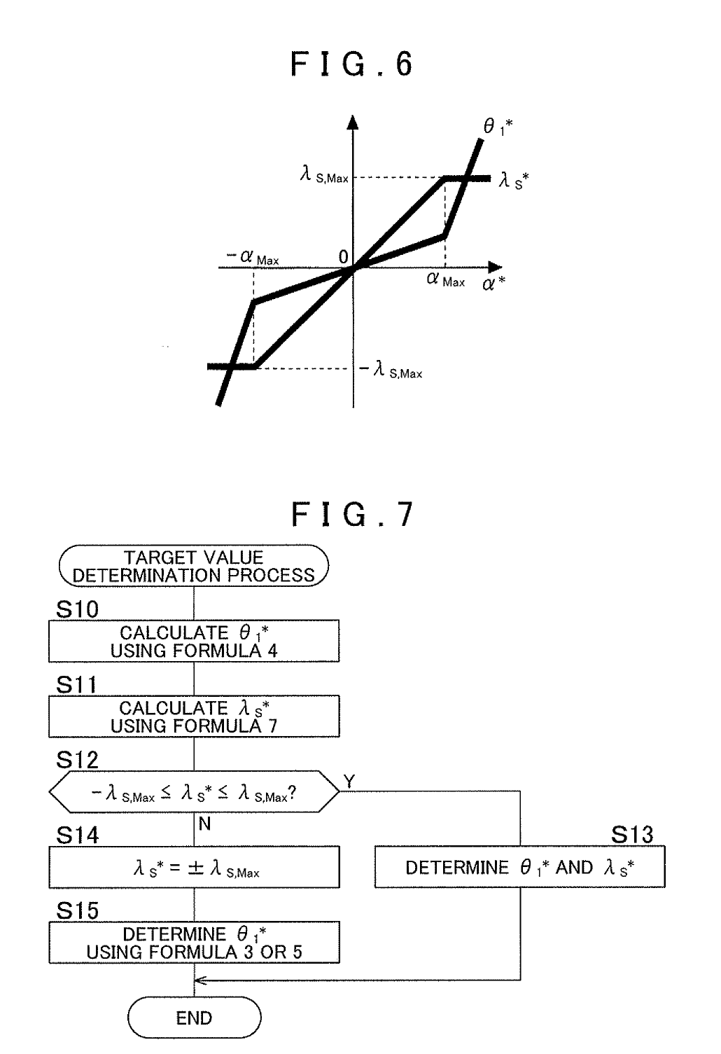

FIG. 6 shows the relationship between the target vehicle acceleration α* (horizontal axis) and the target vehicle body inclination angle θ₁* and the target ride section position λ_{S}* defined by Formulas 3 to 8.

In the case where the target vehicle acceleration α* is in the range between the thresholds ±α_{Max}(−α_{Max}≦α*≦α_{Max}), the target vehicle body inclination angle θ₁* is determined by Formula 4, and the target ride section position λ_{S}* is determined by Formula 7.

Thus, in the range of −α_{Max}≦α*≦α_{Max}, it is possible to provide the passenger with an appropriate sense of acceleration while keeping balance of the vehicle body by moving the ride section at λ_{S}* with the vehicle body inclined at θ₁*.

As described above, in the range between the thresholds ±α_{Max}, movement of the center of gravity necessary to achieve the target vehicle acceleration α* is performed by both inclining the vehicle body and moving the ride section. Assignment of the movement of the center of gravity is determined by a passenger acceleration sensitivity coefficient C_{Sense} used in Formulas 4 and 7. C_{Sense} has a value of 0≦C_{Sense}≦1 which is set in advance.

As the value of the coefficient C_{Sense} is increased for a target vehicle acceleration α*, the target vehicle body inclination angle θ₁* is increased (Formula 4), and the target ride section position λ_{S}* is reduced (Formula 7).

C_{Sense} is equivalent to how much the passenger senses the acceleration.

That is, when C_{Sense} is equal to 1, the target vehicle body inclination angle θ₁* is equal to 0 (Formula 4), at which the vehicle body is not inclined at all and the passenger directly senses an inertial force due to the acceleration/deceleration of the vehicle.

On the other hand, when C_{Sense} is equal to 0, θ₁* is equal to φ* which is equal to tan⁻¹α*, at which the vehicle body is inclined at an equilibrium inclination angle (an angle of the resultant of the gravitational force and the inertial force) and the passenger does not sense the inertial force (it should be noted that the passenger senses an increased downward force).

In the embodiment, C_{Sense} is set in advance to p, which allows the passenger to sense an appropriate acceleration.

For example, in the case where C_{Sense} is equal to 1, all the movement of the center of gravity necessary to achieve the target vehicle acceleration α* is achieved by movement of the ride section 13, and thus the vehicle runs under control in which the vehicle body is maintained in an upright state.

When the ride section movement amount reaches its limits ±λ_{S,Max}, that is, in the case where the target vehicle acceleration α* is less than −α_{Max} or more than α_{Max}, the vehicle body is inclined more significantly to keep balance as shown in FIG. 6 (Formulas 3 and 5).

In the case where there is a sufficient margin in the ride section movement amount, the vehicle body inclination angle may be limited.

{Modification of Determination of Target Vehicle Body Inclination Angle θ₁* and Target Ride Section Position λ_{S}*)

In the description of the above embodiment, one of Formulas 3 to 5 and one of Formulas 6 to 8 are selected depending on the relationship between the target vehicle acceleration α* and the thresholds ±α_{Max} to determine the target vehicle body inclination angle θ₁ and the target ride section position λ_{S}*.

In contrast, the target vehicle body inclination angle θ₁* and the target ride section position λ_{S}* may be determined by a target value determination process shown in FIG. 7.

FIG. 7 is a flowchart showing the content of the target value determination process according to the first embodiment.

The main control ECU 21 first calculates the target vehicle body inclination angle θ_{□}* corresponding to the target vehicle acceleration α* using Formula 4 (step 10).

The main control ECU 21 then calculates the target ride section position λ_{S}* on the basis of the determined angle θ_{□}* using Formula 7 (step 11), and determines whether or not the calculated value λ_{S}* is in the range of −λ_{S,Max}≦λ_{S}*≦λ_{S,Max} in which the ride section is movable (step 12).

If the calculated value λ_{S}* is in the range in which the ride section is movable (step 12: Y), the main control ECU 21 respectively sets the target vehicle body inclination angle and the target ride section position to θ_{□}* calculated in step 10 and λ_{S}* calculated in step 11 (step 13), and terminates the process.

On the other hand, in the case where the calculated value λ_{S}* is outside the range in which the ride section is movable (step 12: N), the main control ECU 21 sets the target ride section position λ_{S}* to the Maximum ride section movement amount ±λ_{S,Max} (step 14).

The main control ECU 21 then recalculates θ₁* corresponding to the target vehicle acceleration α* using Formula 3 or 5, sets the target vehicle body inclination angle 0₁* to the resulting value (step 15), and terminates the process.

According to the above target value determination process, the target vehicle body inclination angle θ₁* and the target ride section position λ_{S}* can be determined without using the threshold α_{Max} for determining which of Formulas 3 to 5 and which of Formulas 6 to 8 to use.

While the target vehicle body attitude is determined using Formulas 3 to 8 which are exact theoretical formulas in the embodiment, the target vehicle body attitude may be determined using simpler formulas. For example, formulas obtained by linearizing Formulas 3 to 8 may be used. Alternatively, a map defining the relationship between the target vehicle acceleration α* and the target vehicle body attitude may be prepared in advance in place of the formulas, and the target vehicle body attitude may be determined using the map.

On the other hand, more complicated relational formulas may be used. For example, it is possible to set relational formulas such that only movement of the ride section is allowed and not any inclination of the vehicle body in the case where the absolute value of the target vehicle acceleration α* is equal to or less than a predetermined threshold, and such that inclination of the vehicle body is allowed in the case where the threshold is exceeded.

While the Maximum forward movement amount and the Maximum backward movement amount of the ride section with respect to the reference position are equal to each other in the embodiment, the amounts may be different from each other. For example, the braking performance can be enhanced compared to the acceleration performance by increasing the Maximum backward movement amount. In this case, similar control can be achieved easily by correcting the threshold α_{Max} in correspondence with each limit value.

Returning to the description of the running/attitude control process (FIG. 5), the main control ECU 21 calculates the remaining target values using each determined target value (step 150).

That is, each target value is differentiated or integrated with respect to the time to calculate the target drive wheel rotational angle θ_{W}*, the target vehicle body inclination angular speed [θ₁*], and the target ride section movement speed [λ_{S}*].

The main control ECU 21 then determines a feedforward output of each actuator (step 160).

The main control ECU 21 determines a feedforward output τ_{W,FF} of the drive motor 52 expected to be necessary to achieve the target vehicle acceleration α* using Formula 9 below. M^{˜} in Formula 9 is the gross mass of the vehicle with the rotational inertia of the drive wheels taken into account.

The main control ECU 21 also determines a feedforward output S_{S,FF} of the ride section motor 62 on the basis of each target value using Formula 30. S_{S,FF} is equivalent to the ride section thrust necessary for the ride section to stay at the target position without being moved by the gravitational force for the target vehicle body inclination angle θ₁*.

τ_{W,FF}=M^{˜}R_{W}gα* (Formula 9)

S_{S,FF}=−m_{S}g sin θ₁* (Formula 30)

It is possible to control each state amount more precisely by providing the feedforward outputs as defined by Formulas 9 and 30.

This method is particularly effective in reducing the stationary deviation in the state amount. Alternatively, feedback control (step 190) may be performed to provide an integral gain.

The main control ECU 21 then acquires each state amount from each sensor (step 170). That is, the main control ECU 21 respectively acquires the drive wheel rotational angle (rotational angular speed), the vehicle body inclination angle (inclination angular speed), and the ride section position (movement speed) from the drive wheel sensor 51, the vehicle body inclination sensor 41, and the ride section sensor 61.

The main control ECU 21 also calculates the remaining state amounts (step 180). That is, the main control ECU 21 integrates or differentiates the drive wheel rotational angle (rotational angular speed), the vehicle body inclination angle (inclination angular speed), and the ride section position (movement speed) with respect to the time to calculate the remaining state amounts.

The main control ECU 21 then determines a feedback output of each actuator (step 190).

That is, the main control ECU 21 determines a feedback output τ_{W,FB} of the drive motor 52 using Formula 31, and determines a feedback output S_{S,FB} of the ride section motor 62 using Formula 32, on the basis of the deviation between each target value and each actual state amount.

K** in Formulas 31 and 32 is a feedback gain, which is set in advance to a value of an optimal regulator, for example. An integral gain may be introduced to eliminate the stationary deviation as discussed above.

τ_{W,FB}=−K_{W1}(θ_{W}−θ_{W}*)−K_{W2}([θ_{W}*]−[θ_{W}*])−K_{W3}(θ₁−θ₁*)−K_{W4}([θ₁]−[θ₁*])−K_{W5}(λ_{S}−λ_{S}*)−K_{W6}([λ_{S}]−[λ_{S}*]) (Formula 31)

S_{S,FB}=−K_{S1}(θ_{W}−θ_{W}*)−K_{S2}([θ_{W}]−[θ_{W}*])−K_{S3}(θ₁−θ₁*)−K_{S4}([θ₁]−[θ₁*])−K_{S5}(λ_{S}−λ_{S}*)−K_{S6}([λ_{S}]−[λ_{S}*]) (Formula 32)

The formulas may be simplified by setting some of the feedback gains to zero. For example, a formula τ_{W,FB}=−K_{W2}([θ_{W}]−[θ_{W}*])−K_{W3}(θ_{1-θ}₁*) may be used in place of Formula 31, and a formula S_{S,FB}=−K_{S5}(λ_{S}−λ_{S}*) may be used in place of Formula 32.

The main control ECU 21 finally provides a command value to each element control system (step 200), and returns to the main routine.

That is, the main control ECU 21 supplies the drive wheel control ECU 22 with the sum (τ_{W,FF}+τ_{W,FB}) of the feedforward output T_{W,FF} determined in step 160 and the feedback output τ_{TW,FB} determined in step 190 as a drive torque command value τ_{W}. The main control ECU 21 also supplies the ride section control ECU 23 with the sum (S_{S,FF}+S_{S,FB}) of the feedforward output S_{S,FF} and the feedback output S_{S,FB} as a ride section thrust command value S_{S}.

The drive wheel control ECU 22 thus supplies the drive motor 52 with an input voltage (drive voltage) corresponding to the drive torque command value τ_{W} in order to provide the drive wheels with a drive torque τ_{W}.

Also, the ride section control ECU 23 is allowed to supply the ride section motor 62 with an input voltage (drive voltage) corresponding to the ride section thrust command value S_{S} in order to move the ride section.

While the mass of the ride section (balancer) is determined in accordance with Formula 2 in the embodiment described above, it may be determined using each of the following formulas.

That is, when the distance from the center of gravity of the vehicle body and the balancer to the rotary shaft of the drive wheels is defined as L₁, and the Maximum vehicle body inclination angle is defined as θ, the balancer mass m may be determined using Formula 13 below which takes the vehicle body inclination into account.

m={(L/λ)α−(L₁/λ)θ}M (Formula 13)

Further, when the ground contact radius of the drive wheels is defined as R_{W}, the mass of the drive wheels and components that rotate together therewith is defined as M_{W}, the inertia moment of the same mass portion about the rotary shaft is defined as I_{W}, and the gross vehicle mass including the rotational inertia-converted mass is defined as M^{˜}=M+I_{W}/R_{W}², the balancer mass may be determined using Formula 14 below which takes the rotational inertia of the drive wheels into account.

m=((M₁L₁+M^{˜}R_{W})/λ)α−(M₁L₁/λ)θ (Formula 14)

Further, with φ=tan⁻¹α, the balancer mass m may be determined using Formula 15 below which derives an exact value with even nonlinear elements taken into account.

m=(M₁L₁/λ)tan(φ−θ)+(M^{˜}R_{W}/λ)sin φ/cos(φ−θ) (Formula 15)

In the embodiment and the modification described above, the gross mass M of the vehicle, the Maximum movement amount λ of the balancer, and so forth are set first, and an optimum balancer mass is determined on the basis of the set values in accordance with one of Formulas 2 and 13 to 15.

In contrast, the gross mass M of the vehicle, the balancer mass in, and so forth may be set first, and the Maximum movement amount λ of the balancer may be determined on the basis of the set values in accordance with Formula 16 which is obtained by transforming Formula 2.

λ=LαM/m (Formula 16)

As with Formula 16 which is obtained by transforming Formula 2, the Maximum movement amount λ of the balancer may be determined in accordance with a formula obtained by transforming one of Formulas 13 to 15.

While the balancer mass m is determined using one of Formulas 2, 13, 14, and 15 and the Maximum movement amount of the balancer is determined using Formula 16 in the illustrated embodiment, the mass m of the balancer obtained using the formula may be used as a minimum value so as to adopt a value equal to or larger than the obtained value.

That is, Formulas 17 to 21 below may be adopted in place of Formulas 2, 13, 14, 15, and 16.

m≧(L/λ)αM (Formula 17)

m ≧{(L/λ)α−(L₁/λ)θ}M (Formula 18)

m≧((M₁L₁+M^{˜}R_{W})/λ)α−(M₁L₁/λ)θ (Formula 19)

m≧(M₁L₁/λ)tan(φ−θ)+(M^{˜}R_{W}/λ(sin φ/(cos(φ−θ))) (Formula 20)

λ≧LαM/m (Formula 21)

1. A vehicle including:
a drive wheel;
a vehicle body rotatably supported on a rotary shaft of the drive wheel;
a balancer disposed to be movable relative to the vehicle body; and
running control means for controlling running while adjusting a center of gravity of the vehicle body by rotating the vehicle body with respect to the rotary shaft and moving the balancer with respect to the vehicle body; and wherein:
when a gross vehicle mass is defined as M, a height of a center of gravity of the entire vehicle is defined as L, a Maximum acceleration/deceleration of the vehicle is defined as α, and a Maximum movement amount of the balancer is defined as λ, a mass m of the balancer is defined by a formula:
m≧(L/λ)αM.

2. A vehicle including:
a drive wheel;
a vehicle body rotatably supported on a rotary shaft of the drive wheel;
a balancer disposed to be movable relative to the vehicle body; and
running control means for controlling running while adjusting a center of gravity of the vehicle body by rotating the vehicle body with respect to the rotary shaft and moving the balancer with respect to the vehicle body; and wherein:
when a gross vehicle mass is defined as M, a height of a center of gravity of the entire vehicle is defined as L, a Maximum acceleration/deceleration of the vehicle is defined as α, a Maximum movement amount of the balancer is defined as λ, a distance from a center of gravity of the vehicle body and the balancer to the rotary shaft of the drive wheel is defined as L₁, and a Maximum vehicle body inclination angle is defined as θ, a mass m of the balancer is defined by a formula:
m≧{(L/λ)α−(L₁/λ)θ}M.

3. A vehicle including:
a drive wheel;
a vehicle body rotatably supported on a rotary shaft of the drive wheel;
a balancer disposed to be movable relative to the vehicle body; and
running control means for controlling running while adjusting a center of gravity of the vehicle body by rotating the vehicle body with respect to the rotary shaft and moving the balancer with respect to the vehicle body; and wherein:
when a gross vehicle mass is defined as M, a height of a center of gravity of the entire vehicle is defined as L, a Maximum acceleration/deceleration of the vehicle is defined as α, a maximum movement amount of the balancer is defined as λ, a distance from a center of gravity of the vehicle body and the balancer to the rotary shaft of the drive wheel is defined as L₁, a Maximum vehicle body inclination angle is defined as θ, a total mass of the vehicle body and the balancer is defined as M₁, a gross vehicle mass including a rotational inertia-converted mass of the drive wheel is defined as M^{˜}, and a ground contact radius of the drive wheel is defined as R_{W}, a mass m of the balancer is defined by a formula:
m≧((M₁L₁+M^{˜}R_{W})/λ)α−(M₁L₁/λ)θ.

4. A vehicle including:
a drive wheel;
a vehicle body rotatably supported on a rotary shaft of the drive wheel;
a balancer disposed to be movable relative to the vehicle body; and
running control means for controlling running while adjusting a center of gravity of the vehicle body by rotating the vehicle body with respect to the rotary shaft and moving the balancer with respect to the vehicle body, and wherein:
when a gross vehicle mass is defined as M, a height of a center of gravity of the entire vehicle is defined as L, a Maximum acceleration/deceleration of the vehicle is defined as α, a maximum movement amount of the balancer is defined as λ, a distance from a center of gravity of the vehicle body and the balancer to the rotary shaft of the drive wheel is defined as L₁, a Maximum vehicle body inclination angle is defined as θ, a total mass of the vehicle body and the balancer is defined as M₁, a gross vehicle mass including a rotational inertia-converted mass of the drive wheel is defined as M^{˜}, a ground contact radius of the drive wheel is defined as R_{W}, and φ=tan⁻¹α, a mass m of the balancer is defined by a formula:
m≧(M₁L₁/λ)tan(φ−θ)+(M^{˜}R_{W}/λ)(sin φ/(cos(φ−θ))).

5. A vehicle including:
a drive wheel;
a vehicle body rotatably supported on a rotary shaft of the drive wheel;
a balancer disposed to be movable relative to the vehicle body; and
running control means for controlling running while adjusting a center of gravity of the vehicle body by rotating the vehicle body with respect to the rotary shaft and moving the balancer with respect to the vehicle body; and wherein:
when a gross vehicle mass is defined as M, a height of a center of gravity of the entire vehicle is defined as L, a Maximum acceleration/deceleration of the vehicle is defined as α, and a mass of the balancer is defined as m, a Maximum movement amount λ of the balancer is defined by a formula:
λ≧LαM/m.

6. The vehicle according to claim 1 wherein:
the gross vehicle mass M and the mass m of the balancer include a mass m_{M} of a ride section and a passenger riding on the ride section.

7. The vehicle according to claim 6, further comprising:
target acquisition means for acquiring a target running state; and wherein:
the balancer is formed to include a passenger and a ride section on which the passenger rides, and
the running control means controls running while adjusting the center of gravity of the vehicle body by rotating the vehicle body with respect to the rotary shaft and moving the ride section with respect to the vehicle body in accordance with the target running state.

8. The vehicle according to claim 7 wherein the running control means includes:
determination means for determining a drive torque of the drive wheel and movement thrust for moving the ride section in accordance with the acquired target running state;
drive means for providing the drive wheel with the drive torque determined by the determination means; and
ride section movement means for providing the ride section with the movement thrust determined by the determination means.

9. The vehicle according to claim 8, further comprising:
target inclination angle determination means for determining a target inclination angle for rotating the vehicle body in accordance with the target running state; and
target position determination means for determining a target position for moving the ride section on the basis of the target running state and the target inclination angle,
wherein the running control means controls running while adjusting the center of gravity of the vehicle body by controlling rotation of the vehicle body and movement of the ride section in accordance with the target running state, the target inclination angle, and the target position.

10. The vehicle according to claim 2 wherein:
the gross vehicle mass M and the mass m of the balancer include a mass m_{M} of a ride section and a passenger riding on the ride section.

11. The vehicle according to claim 3 wherein:
the gross vehicle mass M and the mass m of the balancer include a mass m_{M} of a ride section and a passenger riding on the ride section.

12. The vehicle according to claim 4 wherein:
the gross vehicle mass M and the mass m of the balancer include a mass m_{M} of a ride section and a passenger riding on the ride section.

13. The vehicle according to claim 5 wherein:
the gross vehicle mass M and the mass m of the balancer include a mass m_{M} of a ride section and a passenger riding on the ride section.

14. The vehicle according to claim 1, further comprising:
target acquisition means for acquiring a target running state; and wherein:
the balancer is formed to include a passenger and a ride section on which the passenger rides, and
the running control means controls running while adjusting the center of gravity of the vehicle body by rotating the vehicle body with respect to the rotary shaft and moving the ride section with respect to the vehicle body in accordance with the target running state.

15. The vehicle according to claim 14 wherein the running control means includes:
determination means for determining a drive torque of the drive wheel and movement thrust for moving the ride section in accordance with the acquired target running state;
drive means for providing the drive wheel with the drive torque determined by the determination means; and
ride section movement means for providing the ride section with the movement thrust determined by the determination means.

16. The vehicle according to claim 15, further comprising:
target inclination angle determination means for determining a target inclination angle for rotating the vehicle body in accordance with the target running state; and
target position determination means for determining a target position for moving the ride section on the basis of the target running state and the target inclination angle,
wherein the running control means controls running while adjusting the center of gravity of the vehicle body by controlling rotation of the vehicle body and movement of the ride section in accordance with the target running state, the target inclination angle, and the target position.

17. The vehicle according to claim 2, further comprising:
target acquisition means for acquiring a target running state; and wherein:
the balancer is formed to include a passenger and a ride section on which the passenger rides, and
the running control means controls running while adjusting the center of gravity of the vehicle body by rotating the vehicle body with respect to the rotary shaft and moving the ride section with respect to the vehicle body in accordance with the target running state.

18. The vehicle according to claim 17 wherein the running control means includes:

18. The vehicle according to claim 17 wherein the running control means includes:
determination means for determining a drive torque of the drive wheel and movement thrust for moving the ride section in accordance with the acquired target running state;
drive means for providing the drive wheel with the drive torque determined by the determination means; and
ride section movement means for providing the ride section with the movement thrust determined by the determination means.

19. The vehicle according to claim 18, further comprising:
target inclination angle determination means for determining a target inclination angle for rotating the vehicle body in accordance with the target running state; and
target position determination means for determining a target position for moving the ride section on the basis of the target running state and the target inclination angle,
wherein the running control means controls running while adjusting the center of gravity of the vehicle body by controlling rotation of the vehicle body and movement of the ride section in accordance with the target running state, the target inclination angle, and the target position.

20. The vehicle according to claim 3, further comprising:
target acquisition means for acquiring a target running state; and wherein:
the balancer is formed to include a passenger and a ride section on which the passenger rides, and
the running control means controls running while adjusting the center of gravity of the vehicle body by rotating the vehicle body with respect to the rotary shaft and moving the ride section with respect to the vehicle body in accordance with the target running state.

21. The vehicle according to claim 20 wherein the running control means includes:
determination means for determining a drive torque of the drive wheel and movement thrust for moving the ride section in accordance with the acquired target running state;
drive means for providing the drive wheel with the drive torque determined by the determination means; and
ride section movement means for providing the ride section with the movement thrust determined by the determination means.

22. The vehicle according to claim 21, further comprising:
target inclination angle determination means for determining a target inclination angle for rotating the vehicle body in accordance with the target running state; and
target position determination means for determining a target position for moving the ride section on the basis of the target running state and the target inclination angle,
wherein the running control means controls running while adjusting the center of gravity of the vehicle body by controlling rotation of the vehicle body and movement of the ride section in accordance with the target running state, the target inclination angle, and the target position.

23. The vehicle according to claim 4, further comprising:
target acquisition means for acquiring a target running state; and wherein:
the balancer is formed to include a passenger and a ride section on which the passenger rides, and
the running control means controls running while adjusting the center of gravity of the vehicle body by rotating the vehicle body with respect to the rotary shaft and moving the ride section with respect to the vehicle body in accordance with the target running state.

24. The vehicle according to claim 23 wherein the running control means includes:
determination means for determining a drive torque of the drive wheel and movement thrust for moving the ride section in accordance with the acquired target running state;
drive means for providing the drive wheel with the drive torque determined by the determination means; and
ride section movement means for providing the ride section with the movement thrust determined by the determination means.

25. The vehicle according to claim 24, further comprising:
target inclination angle determination means for determining a target inclination angle for rotating the vehicle body in accordance with the target running state; and
target position determination means for determining a target position for moving the ride section on the basis of the target running state and the target inclination angle,
wherein the running control means controls running while adjusting the center of gravity of the vehicle body by controlling rotation of the vehicle body and movement of the ride section in accordance with the target running state, the target inclination angle, and the target position.

26. The vehicle according to claim 5, further comprising:
target acquisition means for acquiring a target running state; and wherein:
the balancer is formed to include a passenger and a ride section on which the passenger rides, and
the running control means controls running while adjusting the center of gravity of the vehicle body by rotating the vehicle body with respect to the rotary shaft and moving the ride section with respect to the vehicle body in accordance with the target running state.

27. The vehicle according to claim 26 wherein the running control means includes:
determination means for determining a drive torque of the drive wheel and movement thrust for moving the ride section in accordance with the acquired target running state;
drive means for providing the drive wheel with the drive torque determined by the determination means; and
ride section movement means for providing the ride section with the movement thrust determined by the determination means.

28. The vehicle according to claim 27, further comprising:
target inclination angle determination means for determining a target inclination angle for rotating the vehicle body in accordance with the target running state; and
target position determination means for determining a target position for moving the ride section on the basis of the target running state and the target inclination angle,
wherein the running control means controls running while adjusting the center of gravity of the vehicle body by controlling rotation of the vehicle body and movement of the ride section in accordance with the target running state, the target inclination angle, and the target position.
